(19) United States
(12) Patent Application Publication
(10) Pub. No.: US 2018/0067682 A1
(43) Pub. Date: Mar. 8, 2018

(54) Allocation of Hardware Resources to a Logical Grouping of Software Applications

(71) Applicant: International Business Machines Corporation, Armonk, NY (US)

(72) Inventors: Anthony T. Sofia, Hopewell-Junction, NY (US); Elpida Tzortzatos, Lagrangeville, NY (US); Jessie Yu, Wappingers Falls, NY (US)

(21) Appl. No.: 15/255,616

(22) Filed: Sep. 2, 2016

(51) Int. Cl. G06F 3/06; G06F 9/50; G06F 9/445

(52) U.S. Cl. CPC G06F 3/0644; G06F 9/5016; G06F 3/0673; G06F 3/0604; G06F 9/445

(57) ABSTRACT

Systems, methods, and computer-readable media are disclosed for providing a multi-tenant computing environment that allows an authorized user space application within a logical grouping of applications to utilize reserved hardware resources such as processor or memory resources in a manner that isolates the reserved hardware resources from hardware resources utilized by applications outside the logical grouping.

### BACKGROUND

A software solution or software package may include multiple executable software applications that together may form a logical grouping of software applications. Software applications may continually request hardware resources such as memory resources during execution. However, existing solutions for allocating hardware resources to software applications forming part of a logical grouping suffer from a number of drawbacks, particularly when software applications are added or removed from the logical grouping. Discussed herein are technical solutions that address at least some of the drawbacks associated with existing solutions for allocating hardware resources to logically grouped software applications.

### SUMMARY

In one or more example embodiments of the disclosure, a method for managing allocation of physical memory is disclosed. The method includes receiving, by a computing device, a request for memory resources from an executable application configured to execute on the computing device, and determining that the executable application is registered with a memory container of the physical memory. The method further includes determining a container frame pool associated with the memory container, the container frame pool including a portion of the physical memory designated for use by a group of executable applications registered with the memory container, and allocating at least a portion of available memory resources of the container frame pool for use by the executable application.

In one or more other example embodiments of the disclosure, a system for managing allocation of physical memory is disclosed. The system includes at least one memory storing computer-executable instructions and at least one processor configured to access the at least one memory and execute the computer-executable instructions to perform a set of operations. The operations include receiving a request for memory resources from an executable application configured to execute on the system, and determining that the executable application is registered with a memory container of the physical memory. The operations further include determining a container frame pool associated with the memory container, the container frame pool including a portion of the physical memory designated for use by a group of executable applications registered with the memory container, and allocating at least a portion of available memory resources of the container frame pool for use by the executable application.

In one or more other example embodiments of the disclosure, a computer program product for managing allocation of physical memory is disclosed that includes a non-transitory storage medium readable by a processing circuit, the storage medium storing instructions executable by the processing circuit to cause a method to be performed. The method includes receiving, by a computing device, a request for memory resources from an executable application configured to execute on the computing device, and determining that the executable application is registered with a memory container of the physical memory. The method further includes determining a container frame pool associated with the memory container, the container frame pool including a portion of the physical memory designated for use by a group of executable applications registered with the memory container, and allocating at least a portion of available memory resources of the container frame pool for use by the executable application.

### BRIEF DESCRIPTION OF THE DRAWINGS

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. In the drawings, the left-most digit(s) of a reference numeral identifies the drawing in which the reference numeral first appears. The use of the same reference numerals indicates similar, but not necessarily the same or identical components. However, different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

FIG. 1 is a hybrid system/process diagram depicting the allocation of memory resources of a memory container to a logical grouping of registered executable applications in accordance with one or more example embodiments of the disclosure.

FIG. 2 is a process flow diagram of an illustrative method for allocating memory resources of a memory container to a registered executable application in accordance with one or more example embodiments of the disclosure.

FIG. 3 is a process flow diagram of an illustrative method for making additional memory resources available in a memory container for use by a registered executable application in accordance with one or more example embodiments of the disclosure.

FIG. 4 is a schematic diagram of an illustrative computing device configured to implement one or more example embodiments of the disclosure.

### DETAILED DESCRIPTION

Example embodiments of the disclosure include, among other things, systems, methods, computer-readable media, techniques, and methodologies for providing a multi-tenant computing environment that allows a registered user space application within a logical grouping of applications to utilize reserved hardware resources such as processor or memory resources in a manner that isolates the reserved hardware resources from hardware resources utilized by applications outside the logical grouping. The term executable application, or more simply application or variants thereof, may refer to any collection of computer or machine-executable code that when executed causes one or more related operations to be performed. An executable application may include a thread, a process, or the like, and may form part of a larger software package containing multiple logically related applications.

Existing solutions for allocating hardware resources to software applications include, for example, hypervisors that permit hardware resources to be reserved and dedicated to a specific virtual machine. Hypervisors may also disallow over-commitment of hardware resources by limiting a virtual machine to use only the reserved resources. However, hypervisors and other existing solutions for allocating hardware resources suffer from a number of drawbacks. In particular, such existing solutions only allow a single user (e.g., a single virtual machine) to use reserved resources, and do not provide the capability to reserve and allocate hardware resources to a logical grouping of applications.

Example embodiments of the disclosure provide the capability to define a memory container and reserve the memory container for exclusive use by a group of registered applications. A memory container may include physical memory resources that have been reserved for use by a group of registered applications. The physical memory resources of a memory container may be a dedicated range of physical memory or may be specified as some percentage of the total physical memory (which may be randomly allocated to applications in the corresponding registered group). In certain example embodiments, a memory container may be defined statically as part of system initialization. In other example embodiments, existing physical memory may be dynamically assigned to a newly defined memory container or new physical memory may be added to the computing device and then assigned to the memory container.

As previously noted, a group of executable applications may be registered with a memory container to enable any application in the group to utilize memory resources of the memory container. In certain example embodiments, a group of applications registered with a memory container may form part of a logical grouping of applications of a software package or software solution. While in existing solutions, a logical group of applications executing on a same virtual machine may each be permitted to use the resources reserved for the virtual machine, such a technique suffers from a number of drawbacks making it more restrictive than the techniques of example embodiments of the disclosure. For example, applications executing on separate virtual machines are not allowed to share data directly because they are executing on separate, isolated systems. According to example embodiments of the disclosure, applications associated with separate memory containers, on the other hand, are on the same system and are not subject to such a restriction.

An executable application may register with a memory container in any of a variety of ways. For example, an application may register with a memory container via an Application Programming Interface (API) call. As another example, an operating system may register an executable application with a memory container based on attributes of the application including, without limitation, a name of the application, an identifier of the application, or the like. As yet another example, an executable application may be registered with a memory container based on a policy. An executable application that is registered with a memory container may be referred to herein as a registered user, a container user, a registered application, a container application, or the like.

Once registered with a memory container, a request for memory resources by a container user may be accommodated by allocating a portion of the memory resources associated with the memory container to the container user. For example, each time a container user requests and obtains a virtual memory page, physical memory resources from the memory container may be used—at allocation time or reference time-to back up the virtual memory page utilized by the container user. After the container user releases the virtual memory page, the corresponding physical memory resources may be de-allocated and returned to the pool of available memory resources for the memory container. In other example embodiments, the physical memory resources corresponding to a virtual memory page may be freed up after a threshold amount of time has passed since the virtual memory page was last accessed; or to accommodate a request for memory resources from another container user; or the like. Physical memory resources associated with a memory container may be referred to as memory container frames, or more generally memory frames, and in the aggregate, may be referred to as a memory container frame pool.

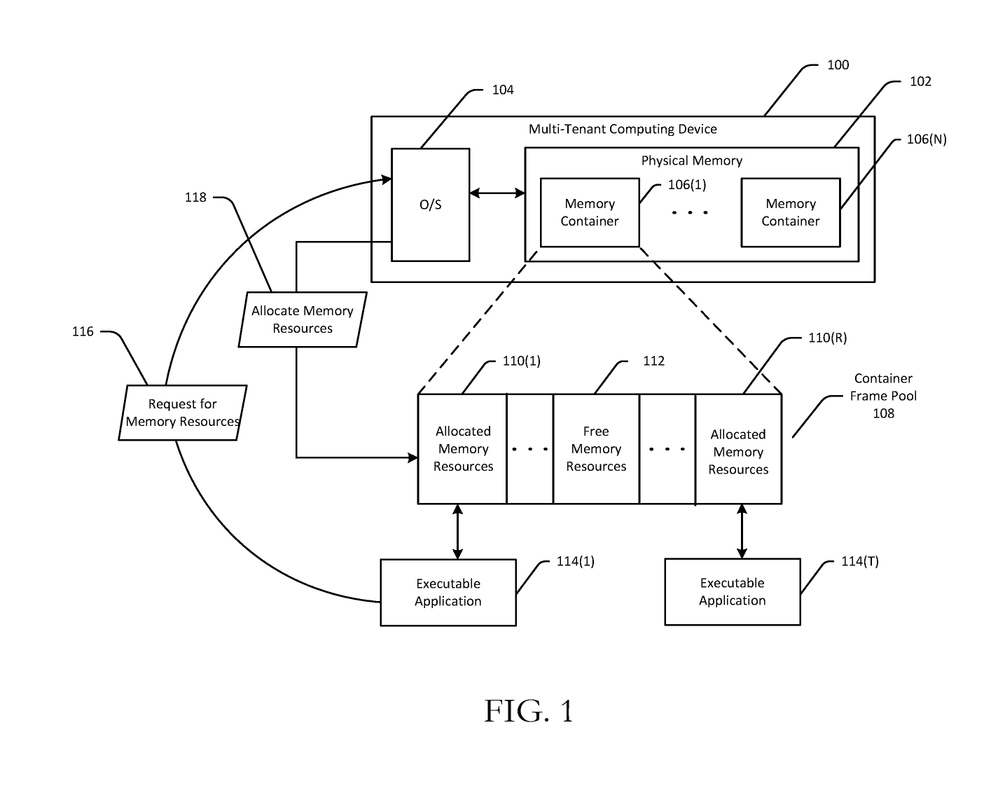

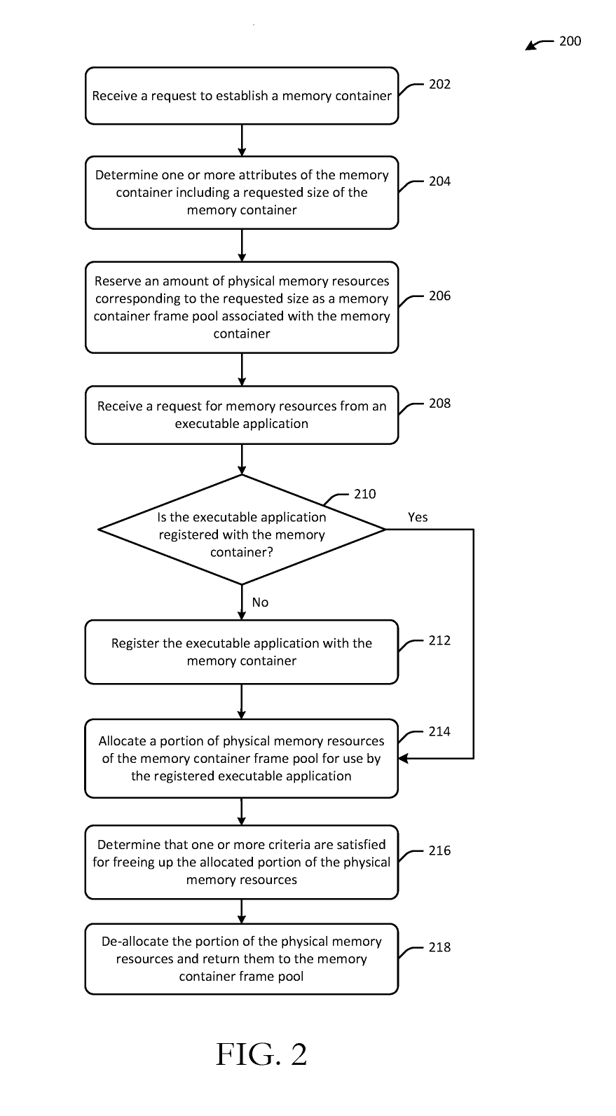

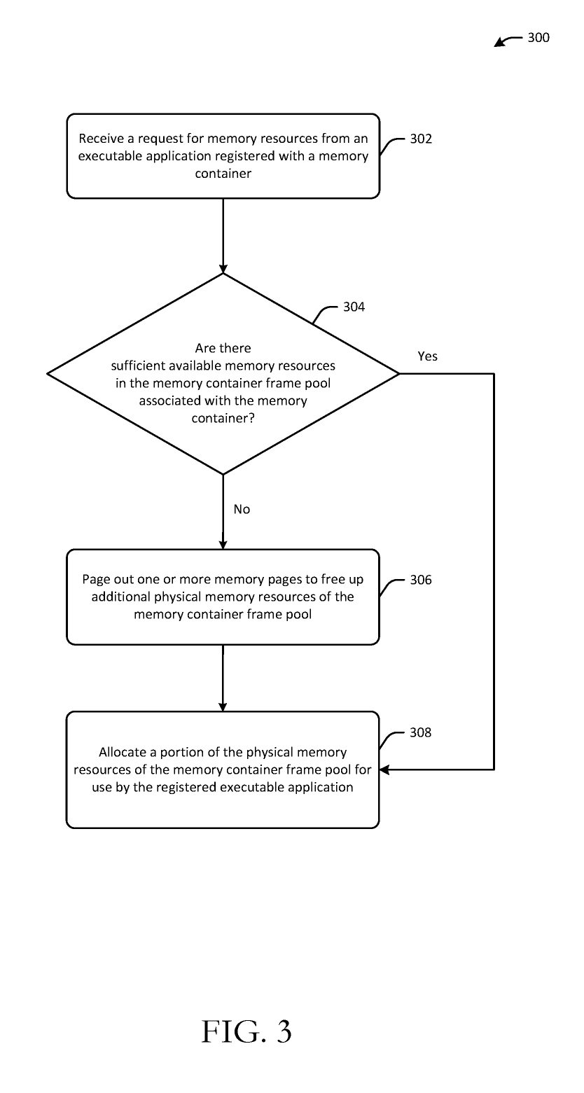

FIG. 1 is a hybrid system/process diagram depicting the allocation of memory resources of a memory container to a logical grouping of registered executable applications in accordance with one or more example embodiments of the disclosure. FIG. 2 is a process flow diagram of an illustrative method 200 for allocating memory resources of a memory container to a registered executable application in accordance with one or more example embodiments of the disclosure. FIG. 3 is a process flow diagram of an illustrative method 300 for making additional memory resources available in a memory container for use by a registered executable application in accordance with one or more example embodiments of the disclosure. FIGS. 2 and 3 will each be described in conjunction with FIG. 1 at times hereinafter.

Each operation of the method 200 and/or the method 300 may be performed by one or more program modules. A program module, which itself may contain or be a collection of one or more sub-modules, may include computer-executable instructions that when executed by a processing circuit may cause one or more operations to be performed. A processing circuit may include one or more processing units or nodes. Computer-executable instructions may include computer-executable program code that when executed by a processing unit may cause input data contained in or referenced by the computer-executable program code to be accessed and processed to yield output data. Any program module described herein may be implemented in any combination of software, hardware, and/or firmware.

Referring first to FIG. 1, a multi-tenant computing device 100 is depicted. The computing device 100 may provide a multi-tenant computing environment in which multiple executable applications may execute on the device 100 and share computing resources (e.g., memory, processing capacity, etc.) of the device 100. The device 100 may include an operating system (“O/S”) 104 and physical memory 102. While not depicted in FIG. 1, it should be appreciated that the device 100 may further include any number of additional hardware and software components such as, for example, one or more processing units (e.g., a central processing unit (CPU)), buses, a network controller, a memory controller, and so forth.

The physical memory 102 may include one or more memory containers 106(1)-106(N) (referred to hereinafter generically as memory container 106). Each memory container 106 may include a portion of the physical memory 102 that has been reserved for use by a particular registered group of executable applications (e.g., a group of logically related software applications).

FIG. 2 illustrates a method 200 for defining a memory container 106 and allocating memory resources of the memory container 106 for use by a registered execution application. FIG. 2 will be described using the memory container 106(1) as an illustrative reference. Further, any program module described as being executable to perform an operation of the method 200 may be provided as part of the O/S 104 functionality or may be provided as a program module separate from the O/S 104.

Referring now to FIGS. 1 and 2 in conjunction with one another, at block 202, the device 100 may receive a request to establish a memory container 106(1). The request may be received from, for example, an executable application (e.g., the executable application 114(1)), from a user of the device 100, or the like.

At block 204, computer-executable instructions of one or more memory container generation modules may be executed by a processing unit of the device 100 to determine one or more attributes of the memory container 106(1). The attributes may be specified in the request and may include, without limitation, a requested size of the memory container 106(1), an identifier for the memory container 106(1), and so forth. In certain example embodiments, the memory container generation module(s) may independently assign a unique identifier to the newly defined memory container 106(1).

At block 206, computer-executable instructions of the memory container generation module(s) may be executed to reserve an amount of physical memory resources corresponding to the requested size of the memory container 106(1). For example, a designated range of the physical memory 102 or some percentage or amount of the physical memory 102 may be reserved as a memory container frame pool 108 for exclusive use by each application 114(1)-114(T) that registers with the memory container 106(1). Similarly, each memory container 106 that is defined in the physical memory 102 may include memory resources that have been reserved for a respective group of registered executable applications. In those example embodiments in which some percentage or amount of the physical memory 102 is reserved as the memory container frame pool 108, the actual physical memory allocated for use by applications registered with the memory container 106(1) may be randomly assigned.

In certain example embodiments, existing physical memory 102 may be dynamically assigned to the newly defined memory container 106(1) or new physical memory may be added to the computing device 100 and then assigned to the memory container 106(1). In other example embodiments, the memory container 106(1) may be defined statically as part of system initialization rather than in response to a request to establish the memory container 106(1).

At block 208, computer-executable instructions of one or more memory container management modules may be executed to receive a request 116 for memory resources from an executable application 114(1). At block 210, the memory container management module(s) may be executed to determine whether the executable application 114(1) is registered with the memory container. In response to a negative determination at block 210, computer-executable instructions of one or more application registration module(s) may be executed by a processing unit of the device 100 to register the executable application 114(1) with the memory container 106(1).

Prior to registering the executable application 114(1) with the memory container 106(1), the application registration module(s) may first determine that the executable application 114(1) is eligible for registration with the memory container 106(1). The executable application 114(1) may be determined to be eligible for registration with the memory container 106(1) based on attributes of the application 114(1) such as a name of the application 114(1), an identifier of the application 114(1), metadata associated with the application 114(1), or the like. First determining eligibility for registration prior to actually registering the application 114(1) with the memory container 106(1) may ensure that only those applications forming part of a logical grouping of applications are allowed to utilize the reserved memory resources of the memory container 106(1). Further, in certain example embodiments, the executable application 114(1) may be implicitly registered with the memory container 106(1) based on attributes of the application 114(1) such as, for example, a name, identifier, authorization level, or the like of the application 114(1).

In those example embodiments in which an application is not eligible for registration with a particular memory container 106, the memory container management modules may be executed to determine whether the application is registered (or eligible for registration) with any other existing memory container 106. If the application is registered or eligible for registration with another memory container 106, memory resources of that memory container 106 may be allocated for use by the application. It should be appreciated that, in certain example embodiments, an application may not be registered with any memory container, in which case, virtual memory pages used by the application may be backed up using generic system memory frames.

Further, in certain example embodiments, an application may be permitted to register with multiple different memory containers 106, whereas in other example embodiments, an application may be permitted to be registered with only one memory container at any given time. In those example embodiments in which an application is registered with multiple memory containers, which memory container to use for allocating memory resources to the application may be determined based on an evaluation of one or more criteria such as, for example, an amount or percentage of available memory resources in the memory container frame pool for each memory container. For example, memory resources may be allocated from the memory container frame pool having the largest amount of available memory resources; the memory container frame pool associated with the memory container having the smallest number of registered applications; the memory container frame pool with the smallest number of applications currently using memory resources of the container frame pool; or the like.

From block 212, the method 200 may proceed to block 214. The method 200 may also proceed to block 214 in response to a positive determination at block 210, in which case, the executable application 114(1) is already registered with the memory container 106(1). For example, the application registration module(s) may have been previously executed to register the application 114(1) with the memory container 106(1) in response to a prior request by the application 114(1) for memory resources. Alternatively, the executable application 114(1) may call an API to register with the memory container 106(1).

At block 214, computer-executable instructions of the memory container management module(s) may be executed to allocate 118 a portion 110(1) of the memory resources of the memory container frame pool 108 for use by the registered executable application 114(1). Other portions of the memory resources of the memory container frame pool 108 may already be allocated to one or more other registered applications. For example, as shown in FIG. 1, a portion 110(R) of the memory resources of the container frame pool 108 may be allocated for use by the executable application 114(T). Further, various portions (e.g., portion 112) of the memory resources of the container frame pool 108 may be unallocated at any given time. While the container frame pool 108 has been described as including both allocated 110(1), 110(R) and unallocated 112 memory resources, it should be appreciated that, in certain example embodiments, the container frame pool 108 may refer only to the memory resources of the memory container 106(1) that are free and available for allocation, whereas the memory container 106(1) may refer to all memory resources (both currently allocated as well as un-allocated) reserved for the registered group of applications 114(1)-114(T).

In certain example embodiments, the executable application 114(1) may continue to obtain and release virtual memory as needed to execute. In particular, virtual memory used by registered users 114(1)-114(T) of the memory container 106(1) may be isolated and protected by normal memory access control. For example, when a virtual memory page used by the executable application 114(1) needs to be backed up with physical memory frames either during allocation time or reference time, the memory container management module(s) may determine whether the application 114(1) is registered with the memory container 106(1), and if so, may utilize a portion 110(1) of the memory resources of the memory container frame pool 108 to back up the virtual memory page. As previously noted, if the application 114(1) is not registered with the memory container 106, the application registration module(s) may register the application 114(1) if determined to be eligible for registration with the memory container 106(1). In other example embodiments, the application 114(1) may implicitly register with the memory container 106(1), as described above.

At block 216, computer-executable instructions of the memory container management module(s) may be executed to determine that one or more criteria are satisfied for freeing up the allocated portion 110(1) of the memory resources. Upon determining that the criteria for freeing up the allocated portion 110(1) of the memory resources are satisfied, the memory container management module(s) may be executed at block 218 to de-allocate the portion 110(1) of the memory resources and return them to the available memory resources of the container frame pool 108.

For example, if the memory container management module(s) determine that the application 114(1) has released a virtual memory page, the corresponding physical memory resources 110(1) may be freed up and made available again for allocation as part of the container frame pool 108. As another example, the memory resources 110(1) may be freed up if the virtual memory page(s) to which the memory resources 110(1) have been allocated are paged out to a hard disk, flash memory, or the like. A virtual memory page utilized by a particular application registered with the memory container 106(1) may be paged out to accommodate a request for memory resources by another application registered with the memory container 106(1). In this manner, the memory resource availability for applications not registered with the memory container 106(1) is not affected by resource demands of applications that are registered with the memory container 106(1). A virtual memory page utilized by a particular application registered with the memory container 106(1) may be paged out based on a page replacement algorithm or policy, which will be described in more detail in reference to FIG. 3.

FIG. 3 illustrates a method 300 for making additional memory resources available in a memory container for a particular registered application by paging out one or more memory pages utilized by one or more applications registered with the same memory container. FIG. 3 will be described with illustrative reference to the memory container 106(1) and the executable application 114(1) depicted in FIG. 1.

At block 302, the memory container management module(s) may receive the request 116 for memory resources from the executable application 114(1) registered with the memory container 106(1). At block 304, the memory container management module(s) may determine whether there are sufficient available memory resources in the memory container frame pool 108. In response to a positive determination at block 304, the memory container management module(s) may proceed to allocate a portion 110(1) of the available memory resources of the container frame pool 108 for use by the registered executable application 114(1), as shown at block 308. However, in response to a negative determination at block 304, the memory container management module(s) may, at block 306, page out one or more virtual memory pages to free up additional physical memory resources of the memory container frame pool 108. A negative determination may be made at block 304 if, for example, the free memory resources 112 of the container frame pool 108 are insufficient to meet the resource demand of application 114(1).

In certain example embodiments, a virtual memory page utilized by a particular application registered with the memory container 106(1) may be paged out to accommodate the request 116 for memory resources by the executable application 114(1) registered with the memory container 106(1). In this manner, the memory resource availability for applications not registered with the memory container 106(1) is not affected by resource demands of applications that are registered with the memory container 106(1). As such, an application registered with the memory container 106(1) that is misconfigured, memory hungry, or the like can only impact the performance of other applications registered with the memory container 106(1) and not other applications executing on the device 100.

A virtual memory page utilized by a particular application registered with the memory container 106(1) may be paged out based on a page replacement algorithm or policy. For example, a page replacement policy may specify that a least recently used virtual memory page is to be paged out to free up additional memory resources if needed to accommodate a memory resource request. Another example page replacement policy may specify that a most recently used virtual memory page is to be paged out under the assumption that data most recently accessed is unlikely to be accessed again within a short period of time. Yet another page replacement policy may specify that virtual memory pages utilized by lower priority applications are to be paged out to accommodate resource requests from applications in the same logical grouping that have a higher priority. It should be appreciated that the above examples of page replacement policies are merely illustrative and not exhaustive.

In certain example embodiments, the application 114(1) may query the memory container 106(1) for its size attributes to determine the amount of available memory resources in the container frame pool 108. The application 114(1) may then size itself to the available memory resources, which may avoid the need to page out memory pages to free up additional memory resources. Further, in certain example embodiments, a container user may switch to a different memory container. For example, the executable application 114(1) may deregister with memory container 106(1) and register instead with another memory container (e.g., memory container 106(N). In such a scenario, the memory container management module(s) may elect to back up all (or some subset) of the in-use memory pages associated with the application 114(1) using physical memory resources associated with the new memory container 106(N) or may instead elect to only back-up new memory pages with memory resources from the memory container 106(N).

While a memory container 106 represents a logical separation of the physical memory resources 102 of the computing device 100, each memory container 106 may be managed independently of each other memory container 106 or multiple memory containers 106 may be managed jointly. If memory containers are managed separately, the memory container management module(s) may initiate a separate process (e.g., a separate page replacement process) for each memory container 106. If management jointly, a single process may be initiated to manage the memory containers collectively. Under such a scenario, the process may take different actions for container memory pages as opposed to a system memory pages. For example, a container memory pages may be preferentially paged out to free up additional memory resources.

Example embodiments of the disclosure provide various technical features, technical effects, and/or improvements to technology. For instance, example embodiments of the disclosure provide the technical effect of logically separating physical memory resources among different logical groups of applications so as to prevent performance degradation of a particular application (e.g., excessive memory consumption) from impacting the performance of other applications that are not part of the same logical grouping. This technical effect is achieved by the technical features of providing a multi-tenant computing environment in which physical memory resources are logically separated into memory containers, where each memory container contains memory resources that are only made available for use by a group of registered (e.g., logically related) applications. By virtue of this technical effect, computational resources (e.g., memory resources) are more efficiently utilized among multiple applications competing for such resources. Thus, example embodiments of the disclosure improve the functioning of a computer. It should be appreciated that the above examples of technical features, technical effects, and improvements to the functioning of a computer and computer technology provided by example embodiments of the disclosure are merely illustrative and not exhaustive.

One or more illustrative embodiments of the disclosure are described herein. Such embodiments are merely illustrative of the scope of this disclosure and are not intended to be limiting in any way. Accordingly, variations, modifications, and equivalents of embodiments disclosed herein are also within the scope of this disclosure.

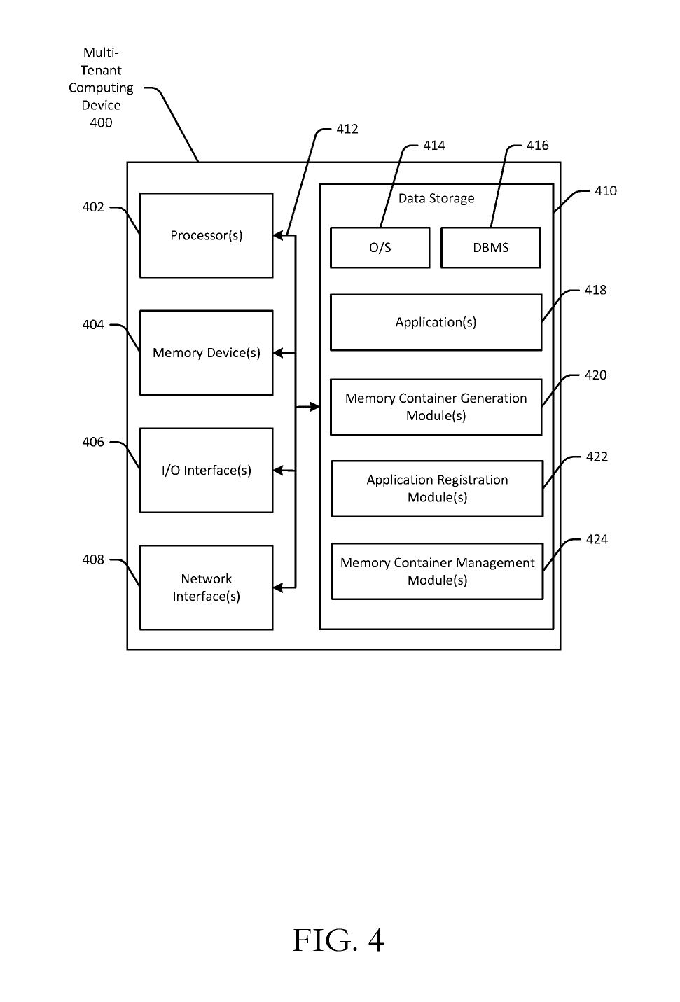

FIG. 4 is a schematic diagram of an illustrative multi-tenant computing device 400 configured to implement one or more example embodiments of the disclosure. The device 400 may be an illustrative configuration of the device 100. While the multi-tenant computing device 400 may be described herein in the singular, it should be appreciated that multiple instances of the device 400 may be provided, and functionality described in connection with the device 400 may be distributed across such multiple instances.

In an illustrative configuration, the multi-tenant computing device 400 may include one or more processors (processor(s)) 402, one or more memory devices 404 (generically referred to herein as memory 404), one or more input/output (“I/O”) interface(s) 406, one or more network interfaces 408, and data storage 410. The multi-tenant computing device 400 may further include one or more buses 412 that functionally couple various components of the multi-tenant computing device 400.

The bus(es) 412 may include at least one of a system bus, a memory bus, an address bus, or a message bus, and may permit the exchange of information (e.g., data (including computer-executable code), signaling, etc.) between various components of the multi-tenant computing device 400. The bus(es) 412 may include, without limitation, a memory bus or a memory controller, a peripheral bus, an accelerated graphics port, and so forth. The bus(es) 412 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

The memory 404 of the multi-tenant computing device 400 may represent the physical memory 102 depicted in FIG. 1 and may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

In various implementations, the memory 404 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 404 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 410 may include removable storage and/or non-removable storage including, but not limited to, magnetic storage, optical disk storage, and/or tape storage. The data storage 410 may provide non-volatile storage of computer-executable instructions and other data. The memory 404 and the data storage 410, removable and/or non-removable, are examples of computer-readable storage media (CRSM) as that term is used herein.

The data storage 410 may store computer-executable code, instructions, or the like that may be loadable into the memory 404 and executable by the processor(s) 402 to cause the processor(s) 402 to perform or initiate various operations. The data storage 410 may additionally store data that may be copied to memory 404 for use by the processor(s) 402 during the execution of the computer-executable instructions. Moreover, output data generated as a result of execution of the computer-executable instructions by the processor(s) 402 may be stored initially in memory 404 and may ultimately be copied to data storage 410 for non-volatile storage.

More specifically, the data storage 410 may store one or more operating systems (O/S) 414 (which may include the O/S 104); one or more database management systems (DBMS) 416 configured to access the memory 404 and/or one or more external data store(s) (not shown); and one or more program modules, applications, engines, computer-executable code, scripts, or the like such as, for example, applications 418, one or more memory container generation modules 420, one or more application registration modules 422, and one or more memory container management modules 424. The applications 418 may include any of the applications configured to execute on the device 400 and utilize memory resources 404 of the device 400. For example, the applications 418 may include the executable applications 114(1)-114(T). Any of the components depicted as being stored in data storage 410 may include any combination of software, firmware, and/or hardware. The software and/or firmware may include computer-executable instructions (e.g., computer-executable program code) that may be loaded into the memory 404 for execution by one or more of the processor(s) 402 to perform any of the operations described earlier in connection with correspondingly named modules.

Although not depicted in FIG. 4, the data storage 410 may further store various types of data utilized by components of the multi-tenant computing device 400 (e.g., memory container attribute data; data indicating which applications are registered with which memory containers; etc.). Any data stored in the data storage 410 may be loaded into the memory 404 for use by the processor(s) 402 in executing computer-executable instructions. In addition, any data stored in the data storage 410 may potentially be stored in external data store(s) and may be accessed via the DBMS 416 and loaded in the memory 404 for use by the processor(s) 402 in executing computer-executable instructions.

The processor(s) 402 may be configured to access the memory 404 and execute computer-executable instructions loaded therein. For example, the processor(s) 402 may be configured to execute computer-executable instructions of the various program modules, applications, engines, or the like of the multi-tenant computing device 400 to cause or facilitate various operations to be performed in accordance with one or more embodiments of the disclosure. The processor(s) 402 may include any suitable processing unit capable of accepting data as input, processing the input data in accordance with stored computer-executable instructions, and generating output data. The processor(s) 402 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 402 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 402 may be capable of supporting any of a variety of instruction sets.

Referring now to other illustrative components depicted as being stored in the data storage 410, the O/S 414 may be loaded from the data storage 410 into the memory 404 and may provide an interface between other application software executing on the multi-tenant computing device 400 and hardware resources of the multi-tenant computing device 400. More specifically, the O/S 414 may include a set of computer-executable instructions for managing hardware resources of the multi-tenant computing device 400 and for providing common services to other application programs (e.g., managing memory container resource allocation). In certain example embodiments, the O/S 414 may include or otherwise control execution of one or more of the program modules depicted as being stored in the data storage 410. The O/S 414 may include any operating system now known or which may be developed in the future including, but not limited to, any server operating system, any mainframe operating system, or any other proprietary or non-proprietary operating system.

The DBMS 416 may be loaded into the memory 404 and may support functionality for accessing, retrieving, storing, and/or manipulating data stored in the memory 404, data stored in the data storage 410, and/or data stored in external data store(s). The DBMS 416 may use any of a variety of database models (e.g., relational model, object model, etc.) and may support any of a variety of query languages. The DBMS 416 may access data represented in one or more data schemas and stored in any suitable data repository. External data store(s) that may be accessible by the multi-tenant computing device 400 via the DBMS 416 may include, but are not limited to, databases (e.g., relational, object-oriented, etc.), file systems, flat files, distributed datastores in which data is stored on more than one node of a computer network, peer-to-peer network datastores, or the like.

Referring now to other illustrative components of the multi-tenant computing device 400, the input/output (I/O) interface(s) 406 may facilitate the receipt of input information by the multi-tenant computing device 400 from one or more I/O devices as well as the output of information from the multi-tenant computing device 400 to the one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. Any of these components may be integrated into the multi-tenant computing device 400 or may be separate. The I/O devices may further include, for example, any number of peripheral devices such as data storage devices, printing devices, and so forth.

The I/O interface(s) 406 may also include an interface for an external peripheral device connection such as universal serial bus (USB), FireWire, Thunderbolt, Ethernet port or other connection protocol that may connect to one or more networks. The I/O interface(s) 406 may also include a connection to one or more antennas to connect to one or more networks via a wireless local area network (WLAN) (such as Wi-Fi) radio, Bluetooth, and/or a wireless network radio, such as a radio capable of communication with a wireless communication network such as a Long Term Evolution (LTE) network, WiMAX network, 3G network, etc.

The multi-tenant computing device 400 may further include one or more network interfaces 408 via which the multi-tenant computing device 400 may communicate with any of a variety of other systems, platforms, networks, devices, and so forth. The network interface(s) 408 may enable communication, for example, with one or more other devices via one or more networks. Such network(s) may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Such network(s) may have any suitable communication range associated therewith and may include, for example, global networks (e.g., the Internet), metropolitan area networks (MANs), wide area networks (WANs), local area networks (LANs), or personal area networks (PANs). In addition, such network(s) may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof

It should be appreciated that the program modules depicted in FIG. 4 as being stored in the data storage 410 are merely illustrative and not exhaustive and that processing described as being supported by any particular module may alternatively be distributed across multiple modules, engines, or the like, or performed by a different module, engine, or the like. In addition, various program module(s), script(s), plug-in(s), Application Programming Interface(s) (API(s)), or any other suitable computer-executable code hosted locally on the multi-tenant computing device 400 and/or hosted on other computing device(s) accessible via one or more networks, may be provided to support functionality provided by the modules depicted in FIG. 4 and/or additional or alternate functionality. Further, functionality may be modularized in any suitable manner such that processing described as being performed by a particular module may be performed by a collection of any number of program modules, or functionality described as being supported by any particular module may be supported, at least in part, by another module. In addition, program modules that support the functionality described herein may be executable across any number of multi-tenant computing devices 400 in accordance with any suitable computing model such as, for example, a client-server model, a peer-to-peer model, and so forth. In addition, any of the functionality described as being supported by any of the modules depicted in FIG. 4 may be implemented, at least partially, in hardware and/or firmware across any number of devices.

It should further be appreciated that the multi-tenant computing device 400 may include alternate and/or additional hardware, software, or firmware components beyond those described or depicted without departing from the scope of the disclosure. More particularly, it should be appreciated that software, firmware, or hardware components depicted as forming part of the multi-tenant computing device 400 are merely illustrative and that some components may not be present or additional components may be provided in various embodiments. While various illustrative modules have been depicted and described as software modules stored in data storage 410, it should be appreciated that functionality described as being supported by the modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional program modules and/or engines not depicted may be present and may support at least a portion of the described functionality and/or additional functionality.

One or more operations of the method 200 or the method 300 may be performed by a multi-tenant computing device 400 having the illustrative configuration depicted in FIG. 4, or more specifically, by one or more program modules, engines, applications, or the like executable on such a device. It should be appreciated, however, that such operations may be implemented in connection with numerous other device configurations.

The operations described and depicted in the illustrative method of FIG. 2 or the illustrative method of FIG. 3 may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIG. 2 or FIG. 3 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular system, system component, device, or device component may be performed by any other system, device, or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like may be additionally based on one or more other operations, elements, components, data, or the like. Accordingly, the phrase “based on,” or variants thereof, should be interpreted as “based at least in part on.”

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for managing allocation of physical memory, the method comprising:
receiving, by a computing device, a request for memory resources from an executable application configured to execute on the computing device;
determining that the executable application is registered with a memory container of the physical memory;
determining a container frame pool associated with the memory container, the container frame pool including a portion of the physical memory designated for use by a group of executable applications registered with the memory container; and
allocating at least a portion of available memory resources of the container frame pool for use by the executable application.

2. The computer-implemented method of claim 1, further comprising determining that the available memory resources of the container frame pool are sufficient to satisfy the request received from the executable application.

3. The computer-implemented method of claim 1, further comprising:
determining that the available memory resources of the container frame pool are insufficient to satisfy the request received from the executable application; and
paging out one or more memory pages to free up additional memory resources of the container frame pool in order to satisfy the request.

4. The computer-implemented method of claim 3, wherein the one or more memory pages are utilized only by one or more other executable applications of the group of executable applications registered with the memory container.

5. The computer-implemented method of claim 1, further comprising:
receiving, by the computing device, a request to establish the memory container, the request specifying a size of the memory container; and
designating the portion of the physical memory corresponding to the size of the memory container as the container frame pool.

6. The computer-implemented method of claim 1, wherein the executable application is a first executable application and the request is a first request, the method further comprising:
receiving, by the computing device, a second request for memory resources from a second executable application configured to execute on the computing device;
determining that the second executable application is not registered with the memory container;
determining one or more attributes of the second executable application;
determining that the second executable application is eligible for registering with the memory container based at least in part on the one or more attributes; and
registering the second executable application with the memory container.

7. The computer-implemented method of claim 1, further comprising:
receiving, from the executable application, via an application programming interface, a request to register with the memory container; and
registering the executable application with the memory container.

8. A system for managing allocation of physical memory, the system comprising:
at least one memory storing computer-executable instructions; and
at least one processor configured to access the at least one memory and execute the computer-executable instructions to:
receive a request for memory resources from an executable application configured to execute on the system;
determine that the executable application is registered with a memory container of the physical memory;
determine a container frame pool associated with the memory container, the container frame pool including a portion of the physical memory designated for use by a group of executable applications registered with the memory container; and
allocate at least a portion of available memory resources of the container frame pool for use by the executable application.

9. The system of claim 8, wherein the at least one processor is further configured to execute the computer-executable instructions to determine that the available memory resources of the container frame pool are sufficient to satisfy the request received from the executable application.

10. The system of claim 8, wherein the at least one processor is further configured to execute the computer-executable instructions to:
determine that the available memory resources of the container frame pool are insufficient to satisfy the request received from the executable application; and
page out one or more memory pages to free up additional memory resources of the container frame pool in order to satisfy the request.

11. The system of claim 10, wherein the one or more memory pages are utilized only by one or more other executable applications of the group of executable applications registered with the memory container.

12. The system of claim 8, wherein the at least one processor is further configured to execute the computer-executable instructions to:
receive a request to establish the memory container, the request specifying a size of the memory container; and
designate the portion of the physical memory corresponding to the size of the memory container as the container frame pool.

13. The system of claim 8, wherein the executable application is a first executable application and the request is a first request, and wherein the at least one processor is further configured to execute the computer-executable instructions to:
receive a second request for memory resources from a second executable application configured to execute on the system;
determine that the second executable application is not registered with the memory container;
determine one or more attributes of the second executable application;
determine that the second executable application is eligible for registering with the memory container based at least in part on the one or more attributes; and
register the second executable application with the memory container.

14. The system of claim 8, wherein the at least one processor is further configured to execute the computer-executable instructions to:
receive, from the executable application, via an application programming interface, a request to register with the memory container; and
register the executable application with the memory container.

15. A computer program product for managing allocation of physical memory, the computer program product comprising a non-transitory storage medium readable by a processing circuit, the storage medium storing instructions executable by the processing circuit to cause a method to be performed, the method comprising:
receiving, by a computing device, a request for memory resources from an executable application configured to execute on the computing device;
determining that the executable application is registered with a memory container of the physical memory;
determining a container frame pool associated with the memory container, the container frame pool including a portion of the physical memory designated for use by a group of executable applications registered with the memory container; and
allocating at least a portion of available memory resources of the container frame pool for use by the executable application.

16. The computer program product of claim 15, the method further comprising determining that the available memory resources of the container frame pool are sufficient to satisfy the request received from the executable application.

17. The computer program product of claim 15, the method further comprising:
determining that the available memory resources of the container frame pool are insufficient to satisfy the request received from the executable application; and
paging out one or more memory pages to free up additional memory resources of the container frame pool in order to satisfy the request.

18. The computer program product of claim 17, wherein the one or more memory pages are utilized only by one or more other executable applications of the group of executable applications registered with the memory container.

19. The computer program product of claim 15, the method further comprising:
receiving, by the computing device, a request to establish the memory container, the request specifying a size of the memory container; and
designating the portion of the physical memory corresponding to the size of the memory container as the container frame pool.

20. The computer program product of claim 15, wherein the executable application is a first executable application and the request is a first request, the method further comprising:
receiving, by the computing device, a second request for memory resources from a second executable application configured to execute on the computing device;
determining that the second executable application is not registered with the memory container;
determining one or more attributes of the second executable application;
determining that the second executable application is eligible for registering with the memory container based at least in part on the one or more attributes; and
registering the second executable application with the memory container.
